(19) United States
(12) Patent Application Publication
(10) Pub. No.: US 2008/0296271 A1
(43) Pub. Date: Dec. 4, 2008

(54) Method and Apparatus for Laser Welding

(75) Inventors: Carl F. Klein, New Berlin, WI (US); Richard B. McCowan, Collierville, TN (US); Joseph W. McElroy, Ann Arbor, MI (US); Mark S. Williamson, Canton, MI (US)

Correspondence Address: BUTZEL LONG;IP DOCKETING DEPT, 350 SOUTH MAIN STREET, SUITE 300, ANN ARBOR, MI, 48104, US

(73) Assignee: JOHNSON CONTROLS TECHNOLOGY COMPANY, Holland, MI (US)

(21) Appl. No.: 11/665,456

(22) PCT Filed: Oct. 27, 2005
(86) PCT No.: PCT/US05/38822

§ 371 Date: Jun. 19, 2008

Related U.S. Application Data
(60) Provisional application No. 60/623,284, filed on Oct. 29, 2004.

(51) Int. Cl. B23K 26/00

(52) U.S. Cl. 219/121.64; 219/121.63

(57) ABSTRACT

A remote beam laser welding system that includes a mechanism comprising at least one mirror for directing a laser beam at a power level greater that approximately 2 kW to a weld spot of a workpiece and a device configured to direct a shielding gas to the weld spot.

### CROSS-REFERENCE TO RELATED APPLICATIONS

The present application claims the benefit of U.S. Provisional Patent Application No. 60/623,284, filed Oct. 29, 2004, the disclosure of which is incorporated herein by reference in its entirety.

### BACKGROUND

The present invention relates generally to remote beam laser welding of metal parts. More particularly, the present invention relates to a method and apparatus for improving the quality of welds formed by a remote beam laser welding process.

Laser welding is a non-contact welding process in which the energy of a laser beam melts and vaporizes the workpiece to form a weld. The use of laser welding systems in the automotive industry has expanded with increased demand for improved production quality, production efficiency, and flexibility as compared to more conventional welding processes (e.g., resistance spot welding, gas metal arc welding (e.g., metal inert gas (MIG)), tungsten inert gas (TIG), etc.).

When lasers were initially used in the automotive industry as an alternative to conventional welding processes, a work head (the point where the laser beam is transferred from the welding system to the workpiece) was typically mounted to the end of a robot arm and the work head (and thus the robot arm) had to be positioned substantially near the workpiece during the welding operation. Such systems are still commonly used today, although the speed of such systems is limited by the need to reposition the robot arm to each weld spot during a welding process.

More recently, remote beam laser welding systems have been developed to improve the efficiency of the laser welding process. In a remote beam laser welding system, the work head is positioned at a standoff distance from the workpiece and typically remains stationary during the welding process. A mirror system coupled to the work head is employed to direct the laser beam to the various spots to be welded on the workpiece (e.g., weld spots, weld joints, etc.).

Two welding methods employed during laser welding operations are diffusion welding and keyhole welding. In diffusion welding, the laser beam penetrates completely through a first layer of material and only partially through a second layer of material. In a diffusion welding process it is often difficult to determine if a sufficient weld has been made. In keyhole welding, the laser beam penetrates completely through both the first and second layers of material. Penetration of the second layer will leave a trace of weldment (e.g., heat affected zone, heat stress marks, etc.) indicating that complete penetration was achieved.

During a remote beam laser welding process, as with other laser welding processes, a laser beam is directed onto a workpiece and forms a hole, known as a “keyhole,” at least part way through the workpiece. The term “workpiece” is used herein generally to describe the two or more pieces (e.g., materials, etc.) being welded together. As shown in FIG. 1, a workpiece 10 includes a first material 12 and a second material 14 having a keyhole 18 formed therein during the welding process. Molten metal is displaced to the keyhole periphery to form a molten pool 20 as a laser beam 56 penetrates the workpiece 10. As the laser beam 56 moves away from an area of the weld spot (i.e., the location of the weldment), the molten pool 20 resolidifies to form the weldment.

In order for the laser beam to penetrate through a workpiece, the keyhole must remain open. In addition to the keyhole remaining open, the keyhole should remain stable during penetration to provide a weld with reduced porosity.

Previously, remote beam laser welding systems used a relatively low power level (e.g., below 2 kilowatts (kW)). When using a laser beam having a power level below 2 kW with a remote beam laser welding system, the elemental composition, or electron density, of the generated plasma did not adversely effect the formation and/or stability of the keyhole. Accordingly, the relatively low-powered remote beam laser welding systems can be operated without significant adverse consequences resulting from the formation of laser-induced plasma.

More recently, automotive manufacturers have sought to use higher powered lasers (e.g., CO₂ lasers operating at power levels greater than approximately 2 kW) to increase the depth of penetration that can be achieved, the quality of the penetration, and/or the speed of penetration through the material by the laser beam. However, the use of higher powered lasers has been limited because a laser-induced plasma is generated during penetration that absorbs and reflects the incoming laser beam and threatens the stability of the keyhole (see, e.g., FIG. 1, which shows a plasma plume 23 generated during the welding process). Instability or collapse of the keyhole during a welding process may cause significant problems in the weld quality and in the overall production of the workpiece.

Accordingly, there is a need for an improved remote beam laser welding process that utilizes a laser having a power level greater than approximately 2 kW and that increases penetration and/or reduces porosity in welds formed by such a process. There is also a need for a remote beam laser welding process that reduces or eliminates the effects of laser-induced plasma that may be formed in such processes. There is a need for a process and/or system that includes any one or more of these or other advantageous features as will be apparent to those reviewing this disclosure.

### SUMMARY

An exemplary embodiment of the present invention relates to a remote beam laser welding system that includes a mechanism comprising at least one mirror for directing a laser beam at a power level greater than approximately 2 kW to a weld spot of a workpiece and a device configured to direct a shielding gas to the weld spot.

Another exemplary embodiment of the present invention relates to a method of welding a workpiece that includes providing a flow of shielding gas to a weld spot on a workpiece, the gas having a flow direction and directing a laser beam at the weld spot using a remote beam laser welding system. The method also includes forming a weld by moving the laser beam in a direction different than the flow direction to reduce interaction between the laser beam and a plasma plume formed proximate the weld spot.

### BRIEF DESCRIPTION OF THE DRAWINGS

FIG. 1 is a schematic drawing illustrating the basic elements of a laser welding process.

FIG. 2 is a schematic drawing of a remote beam laser welding system welding a workpiece according to an exemplary embodiment.

FIG. 3 is a perspective view of a vehicle seat frame configured to be welded by a remote beam laser welding process.

FIG. 4 is a perspective view of multiple fixture systems configured to clamp a workpiece and supply a shielding gas during a remote beam laser welding process according to an exemplary embodiment.

FIG. 5 is a enlarged view of the fixture system of FIG. 4 according to an exemplary embodiment.

FIG. 6 is a perspective view of a fixture system according to a first exemplary embodiment.

FIG. 7 is a perspective view of a fixture system according to a second exemplary embodiment.

FIG. 8 is a perspective view of a fixture system according to a third exemplary embodiment.

FIG. 9 through 17 are schematic top cross-sectional views of a fixture system defining a weld spot in which varying weld patterns are illustrated.

FIG. 18 is a schematic drawing of the components defining a segment of a weld pattern.

FIG. 19 is a schematic drawings of the components of a tangential line of a segment of a weld pattern.

FIG. 20 is a schematic top cross-sectional view of a fixture system according to an exemplary embodiment.

### DETAILED DESCRIPTION

According to an exemplary embodiment, a system and process for remote beam laser welding is provided that improves the quality of the resulting welds and overcomes difficulties associated with the use of relatively high-powered (e.g., greater than approximately 2 kW) lasers. According to this exemplary embodiment, the plasma generated during penetration is suppressed or redirected to maintain the keyhole, which enables more complete penetration through the workpiece and improved stability of keyholes formed during the welding process.

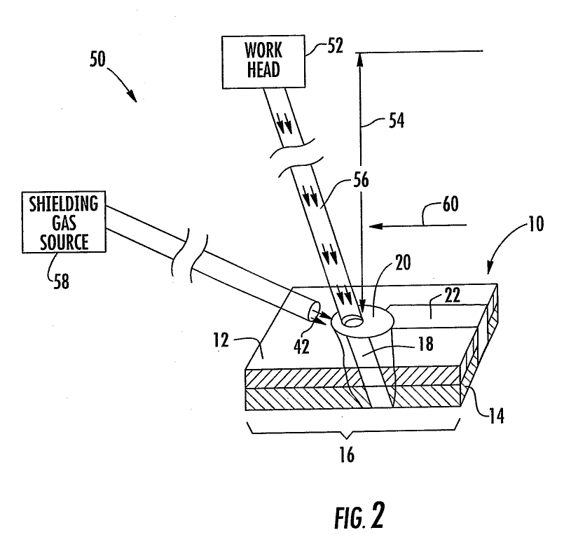

With reference to FIG. 2, a method of increasing penetration and/or reducing porosity of a weld formed by a remote beam laser welding process includes the step of supplying (e.g., delivering, distributing, releasing, providing, etc.) a shielding gas (represented in FIG. 2 by arrows 42) to a weld spot 16 of a workpiece 10 during the welding process. For purposes of this disclosure, the phrase “to a weld spot” is used generally to mean near and/or at a weld spot. The phrase is used throughout this disclosure in reference to the supplying of a shielding gas and, as detailed below, in reference to applying a clamping force. The phrase is used generally to describe a position that is sufficiently close to effectively deliver the shielding gas and/or transfer a clamping force.

Still referring to FIG. 2, a remote beam laser welding system 50 (utilizing, for example, a CO₂ laser) generally includes a work head 52 positioned at a standoff distance 54 from workpiece 10. Workpiece 10 generally includes two materials being welded together, a first layer 12 and a second layer 14. Work head 52 includes a mirroring device (not shown) capable of selectively altering the positioning of a laser beam 56 onto workpiece 10. Laser beam 56 is moved relative to the workpiece 10 in a direction represented by an arrow 60 in FIG. 2. According to an exemplary embodiment, laser beam 56 has power level greater than approximately 2 kW and is preferably approximately 4 kW and is positioned at a standoff distance 54 of approximately one meter. The shielding gas is supplied from a shielding gas source 58. Remote beam laser welding system 50 forms a keyhole 18 through workpiece 10 thereby forming a molten pool 20 of metal which cools and resolidifies to form a weld 22.

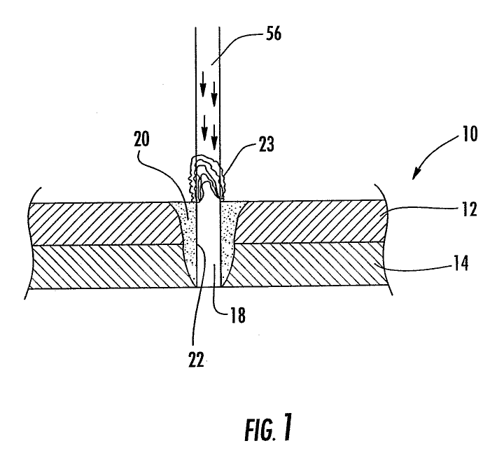

As mentioned above, when a remote beam laser welding system utilizes a laser beam having a power level of approximately 2 kW or greater, the laser-induced plasma (e.g., keyhole plasma 21 existing inside the keyhole and/or plasma plume 23 existing outside the keyhole, as shown in FIG. 1) generated during penetration acts as an impediment to further penetration. The plasma impedes laser beam, penetration by reflecting and/or absorbing the energy of the laser beam thereby threatening the stability of the keyhole. Keyhole instability causes increased porosity in the resulting weld and/or inconsistent penetration and thus a non-uniform weld. In addition, severe keyhole instability may cause a collapse of the keyhole thereby blocking further penetration and no weld between the layers. Shielding gas 42 increases penetration and/or reduces porosity by interacting with the laser-induced plasma and suppressing the plasma that otherwise reduces the energy of the laser beam (e.g., defocuses the laser beam).

The degree and/or rate at which penetration can be achieved affects the overall efficiency of the remote beam laser welding process and should be optimized and kept constant whenever practically possible. By suppressing the laser-induced plasma, an improved remote beam laser welding process is realized, namely a remote beam laser welding process providing a higher degree and/or rate of penetration into workpiece 10, a more consistent penetration, and an improved finished weld having reduced porosity.

The method described herein may be employed in a variety of remote laser beam welding applications, and is generally applicable with any remote beam laser welding application that utilizes a laser having a power level sufficient to generate a plasma that impedes penetration through a workpiece (e.g., a plasma that reflects the laser beam thereby reducing the energy of the laser beam, etc.). In one embodiment, the method disclosed herein is employed during the welding of a vehicle seat frame, such as a seat back frame. While the disclosed embodiments may be described and illustrated as a method used in the welding of a vehicle seat frame, the features of the disclosed embodiments are equally applicable with other remote beam laser welding processes where the laser beam power generates a plasma.

FIG. 3 is a perspective view of a vehicle seat frame system 200 that is designed to be welded together by a remote beam laser welding process. Seat frame system 200 includes a pair of spaced apart side support members 210, 212, an upper cross support member 214, and a lower cross support member 216 that are configured to be welded together at a plurality of weld spots 16. A method of welding a vehicle seat frame system 200 includes the step of supplying a shielding gas to each weld spot 16 before and/or during when laser beam 56 is directed to the particular weld spot from work head 52.

Considering the speed at which remote beam laser welding system 50 can weld the vehicle seat frame system 200 (e.g., for a vehicle seat frame system having around 20 weld spots, the weld process may take as little as 5 seconds), the shielding gas may be supplied during the entire welding process or alternatively may be applied intermittently to coincide with the weld spot 16 currently being welded by laser beam 56.

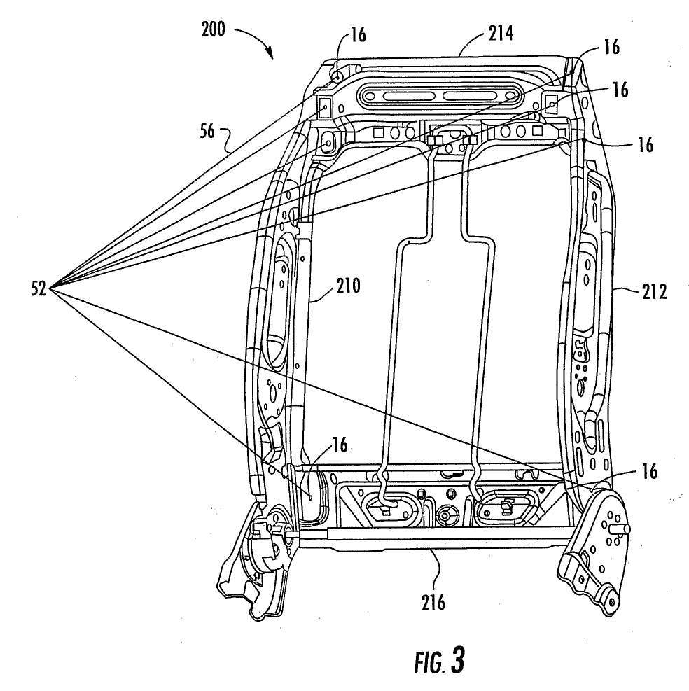

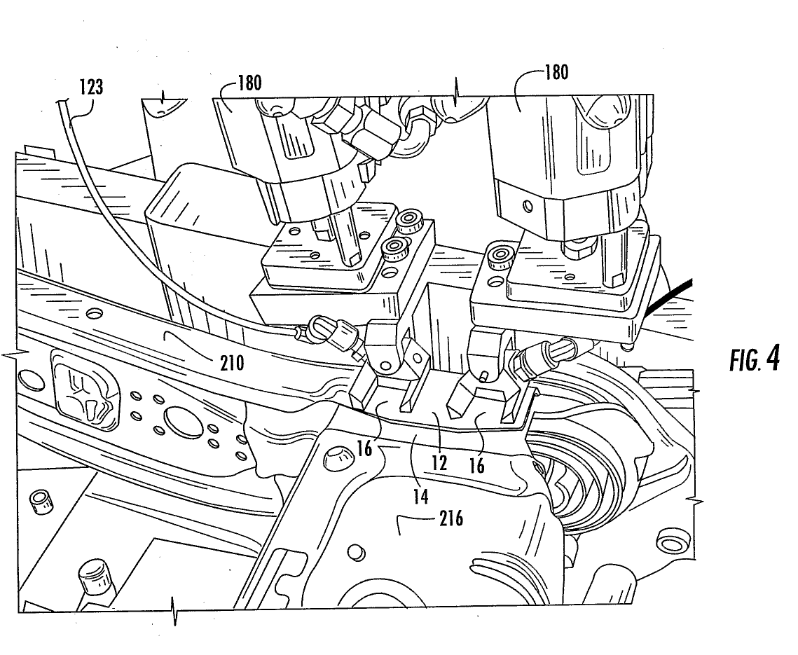

Referring to FIGS. 4-8, a device or structure in the form of a fixture system 100 is shown according to several exemplary embodiments that is configured to supply a shielding gas to weld spot 16. Fixture system 100 is suitable for welding workpiece 10 having layers 12 and 14 (shown in FIG. 2). According to an exemplary embodiment, fixture system 100 is illustrated and described as a fixture system suitable for the welding of a vehicle seat frame or similar structure.

Fixture system 100 is designed to both supply a shielding gas (represented by arrows 42 throughout the FIGURES) to weld spot 16 and to transfer a clamping force to the weld spot. Providing a single fixture system that functions as both the fixture used to supply a shielding gas to the weld spot and as the fixture used to provide a clamping force to the weld spot advantageously reduces the tooling needed around the weld spot. However, it is possible to have separate fixtures or components for providing a shielding gas and providing a clamping force. Such separate components may be sized to minimize the tooling around the weld spot. Minimizing tooling around the weld spot increases flexibility in the available “line of sight” (i.e., a line extending between work head 52 and weld spot 16) for laser beam 56. As can be appreciated, the line of sight must remain unobstructed to achieve an acceptable weld from the laser beam.

The shielding gas used in the described method can be any suitable gas, or mixture of suitable gases, sufficient to suppress or redirect (e.g., remove, reduce, dissipate, etc.) the plasma generated by a relatively high-powered laser beam (e.g., laser beams having a power level greater than approximately 2 kW). According to any exemplary embodiment, the shielding gas is an inert gas, or a mixture of or including an inert gas. According to an exemplary embodiment, the shielding gas is helium. According to another exemplary embodiment, nitrogen is used as the shielding gas. According to another exemplary embodiment, air is used as the shielding gas. As can be appreciated, the type of shielding gas employed may vary based on the particular material to be welded and the economics involved.

Fixture system 100 includes abase, shown as a body portion 120 having a first aperture (e.g., opening, orifice, hole, etc.) shown as a shielding gas inlet 122, and a second aperture, shown as a shielding gas outlet 124. Inlet 122 is fluidly coupled to shielding gas supply source 58 (shown in FIG. 2) and according to an exemplary embodiment, is fluidly coupled to shielding gas supply source 58 by a conduit 123 or any other suitable device (e.g., tube, duct, passage, etc.). Outlet 124 is fluidly coupled to inlet 122 and opens toward weld spot 16 to supply (e.g., deliver, disperse, provide, etc.) the shielding gas to weld spot 16.

Fixture system 100 further includes an attachment portion 160 operably coupled to a clamping system 180. Clamping system 180 provides a clamping force (represented in FIGS. 6 through 8 as an arrow 161) to fixture system 100 which is in turn transferred to weld spot 16. Clamping force 161 is of sufficient magnitude to draw first layer 12 and second layer 14 together an amount necessary to achieve and maintain a desired gap width between the layers. According to an exemplary embodiment, clamping system 180 is a relatively fast acting pneumatic cylinder. Other clamping systems may be employed including, but not limited to, slower acting hydraulic cylinders, mechanical actuators, motors or the like.

Fixture system 100 further includes a clamping surface (e.g., bottom surface, etc.), shown as an interface surface 130, configured to transfer clamping force 161 to first layer 12 and/or second layer 14. Interface surface 130 is configured to mate with first layer 12 and accordingly may have a surface contour corresponding to that of the first layer. According to an exemplary embodiment, interface surface 130 is a relatively flat surface configured to interact/contact with one of side support members 210, 212 and/or upper and lower support members 214, 216 of a vehicle seat frame system 200 (shown in FIGS. 3-5).

As can be appreciated, to achieve an acceptable weld, the gap size (e.g., width) between first layer 12 and second layer 14 needs to be minimized. According to an exemplary embodiment, the gap size between layers 12, 14 is less than approximately 0.3 mm (and/or a gap size that is approximately 2 percent of the thickness of the thinnest material of the workpiece) and is preferably approximately 0.1 mm. As can be appreciated, with improvements in welding technology, and in particular laser welding technology, a greater gap size may be acceptable.

According to an exemplary embodiment, a force measuring system (not shown) is used with the remote beam laser welding process to measure the amount of force being applied to workpiece 10 by clamping system 180 acting upon fixture system 100. By knowing the magnitude of the force being applied to workpiece 10, the gap size existing between the materials of workpiece 10 can be determined. Accordingly, the remote beam laser welding process may be configured and/or controlled (e.g., programmed, operated, etc.) to refrain from welding a weld spot until the desired gap size is achieved. The force measuring system may be provided as a strain gauge or load cell. According to an exemplary embodiment, the force measuring system is coupled to a structure or base configured to support workpiece 10 during the welding process. According to an exemplary embodiment, the force measuring system is operably coupled to a display and/or a processing unit (not shown) to provide a visual output representative of the force magnitude. As can be appreciated, any number of a variety of force measuring systems may be used, and/or other systems configured to provide an indication of the gap size existing between the materials of weld piece 10 when a force is applied by clamping system 180.

Fixture system 100 further includes at least one auxiliary clamping surface (e.g., extension, projection, etc.), designed to increase the clamping force that can be transferred to weld spot 16 while maintaining a configuration that minimizes any interference with the line of sight of laser beam 56. According to the particular embodiment illustrated, the auxiliary clamping surface is provided by the bottom surfaces 133, 135 of a pair spaced apart legs 132, 134 that extend outward from body portion 120. Legs 132, 134 together with body portion 120 define a generally U-shaped window (laser beam access area) around weld spot 16.

Legs 132 and 134 are integrally formed with body portion 120, but in other exemplary embodiments may be separate members coupled to body portion 120 using any suitable fastener. The addition of legs 132 and 134 is intended to more evenly draw the at least two members of workpiece 10 together to achieve and maintain the desired gap size between the members being welded. As can be appreciated, fixture system 100 is not limited to the use of two legs and may include any configuration designed to maintain the needed gap size while not interfering with the line of sight of the laser beam.

According to the particular embodiments illustrated, legs 132 and 134 include angled or inclined surfaces 136 and 138 respectively. Inclined surfaces 136 and 138 are intended to provide additional clearance for laser beam 56 emanating from work head 52. While FIGS. 4 through 8 illustrate inclined surfaces on both legs 132 and 134, according to other exemplary embodiments, only one leg may include an incline surface depending on the position of work head 52 and the body portion 120.

Prior to and/or during welding, the shielding gas is supplied to fixture system 100 from shielding gas source 58. The shielding gas enters body portion 120 through inlet 122. Once the shielding gas enters body portion 120, the shielding gas passes through a conduit, passage, or channel (an exemplary embodiment of a manifold is shown in FIGS. 9 through 17) before exiting through outlet 130. According to an exemplary embodiment, a chamber (not shown) is disposed between inlet 122 and outlet 124 and is configured to receive and retain the shielding gas. In such a configuration, the chamber may be at least partially used to regulate the pressure of the shielding gas and/or the gas flow rate before the shielding gas is applied to the weld spot 16.

Fixture system 100 optionally includes a valve or system of valves (not shown) for selectively controlling the release of the shielding gas. For example, a valve may be used to prevent the shielding gas from entering body portion 120 until just prior to welding. In another embodiment, a valve may be used to hold the shielding gas in body portion 120 until just prior to welding. Further, a control system (not shown) would be utilized to control the timing of when the shielding gas is provided. In certain applications, it may be desirable to have a control system which coordinates the release of the shielding gas with the weld process for a specific weld spot 16. According to other exemplary embodiments, it may be desirable to provide shielding gas throughout the entire welding process and possibly between welding processes.

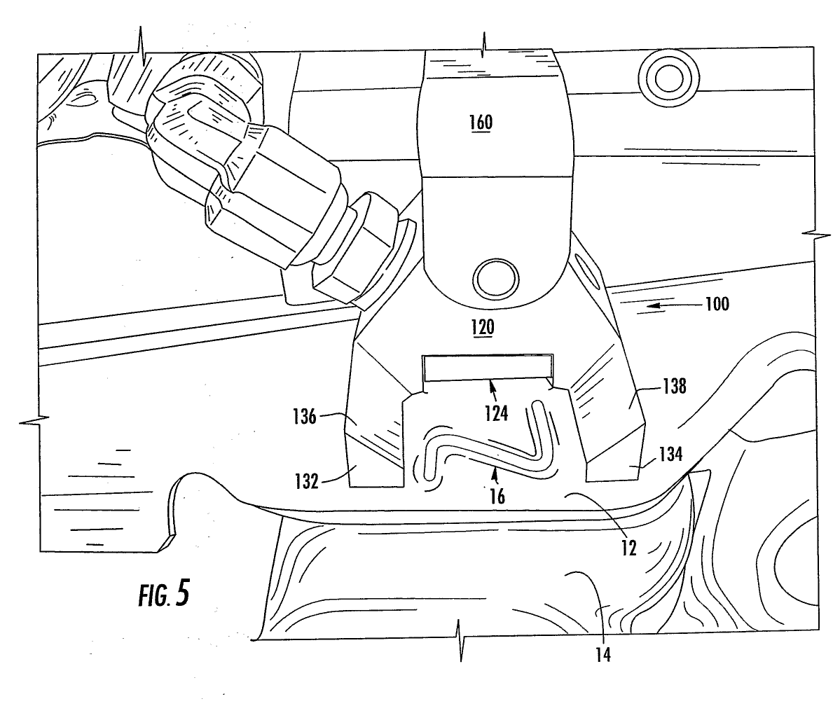

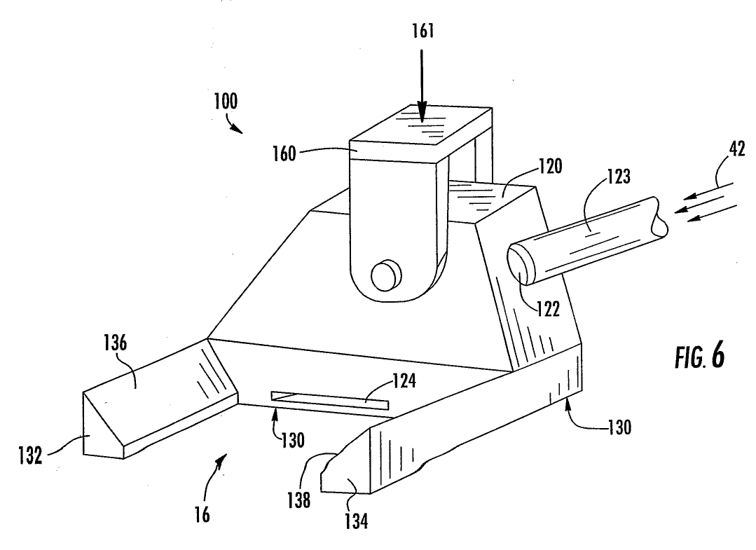

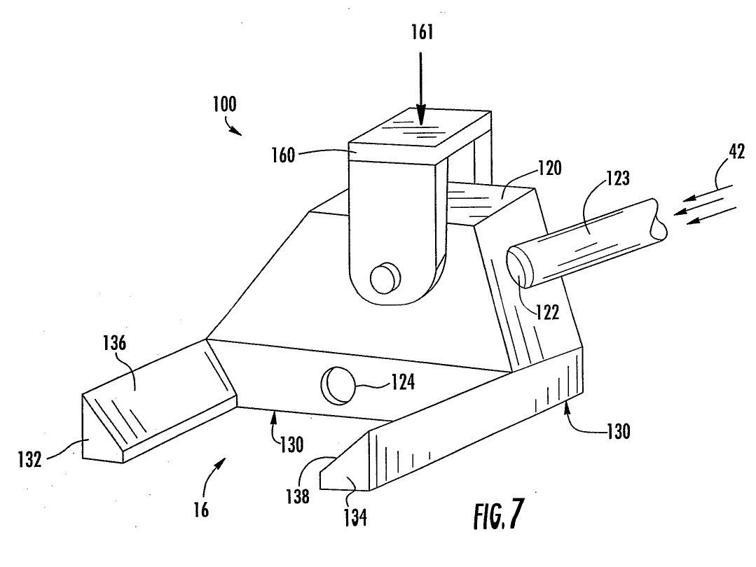

Referring to FIGS. 6 through 8, outlet 124 is selectively positioned to provide the shielding gas to weld spot 16. According to an exemplary embodiment, outlet 124 is sized to allow the shielding gas to enter (e.g., flood, etc.) the entire area of weld spot 16. Outlet 124 may have a variety of configurations including, but not limited to, a single aperture that is substantially rectangular in shape as shown in FIG. 6, a single aperture that is substantially rounded or circular in shape, as shown in FIG. 7, or a plurality of apertures, as shown in FIG. 8. As can be appreciated, any number of configurations and shapes may be provided for outlet 124.

The material used for the components and/or elements of fixture system 100 can be selected from those known to the art, including steel, various other alloys, or high strength metals such as SAE J2340 340XF steel and steel alloys. According to an exemplary embodiment, the components and/or elements of fixture system 10 are made of hardened steel.

According to an exemplary embodiment (not shown), fixture system 100 may be designed to simply supply shielding gas 42 to weld spot 16 during a remote laser beam welding process, rather than functioning as a supply for the shielding gas and as a clamping device. For such a configuration, fixture system 100 may include a nozzle having an inlet for receiving a shielding gas from the shielding gas supply source and an outlet for dispersing the shielding gas to the weld spot. A bracket mechanism or other mounting structure may be provided for supporting the nozzle and directing the nozzle to the weld spot.

To realize the full effectiveness of applying the shielding gas to weld spot 16, the path the laser beam follows relative to the surface of the workpiece at each weld spot 16 (referred to herein as a “weld pattern”) should be dictated by the direction in which the shielding gas is supplied to the weld spot (i.e., the flow direction of the shielding gas). It has been discovered that when applying a shielding gas in a particular direction (i.e., a flow direction), there is a relationship between the weld pattern and the quality (e.g., degree, etc.) of laser penetration achieved and/or with the quality level of the porosity in the resulting weld. More particularly, it has been discovered that when the laser beam is moved relative to the workpiece in a direction that is primarily away from the source of the shielding gas (i.e., the laser is moving primarily in the same direction as the flow of the gas), the weld experiences reduced penetration and/or increased porosity. It has also been discovered that the weld experiences a relatively high quality of penetration with reduced porosity when the laser beam is moved in a direction that is “against” or opposite the flow of the shielding gas (i.e., the laser beam moves toward the source of the shielding gas).

FIGS. 9 through 17 illustrate varying embodiments of weld patterns wherein the laser beams is always moving in a direction that is either substantially transverse (i.e., perpendicular) to the flow direction of shielding gas 42 or in a direction that is substantially into (e.g., frontal to, towards, counter, opposite, etc.) the flow direction of shielding gas 42. In FIGS. 9 through 17, arrows 42 represent the shielding gas and the flow direction of the shielding gas. Such weld patterns optimize the effectiveness of the shielding gas by allowing the shielding gas to better interact with the laser-induced plasma thereby suppressing the plasma and improving the penetration of the laser beam and/or reducing porosity in the resulting weld. For each weld pattern, the direction that the laser beam follows along the weld pattern is represented by arrows 35. As can be appreciated, the weld patterns may be altered if the flow direction of the shielding gas is altered relative to the direction of the laser beam.

Referring particularly to FIG. 9, a weld pattern 300 according to one exemplary embodiment is shown. The laser beam begins welding at a start point 30 and stops welding at end point 40. The illustrated weld pattern 300 is substantially a Z-shaped weld pattern having a first segment 31 (e.g., portion, leg, etc.) extending in a direction that is substantially parallel with the flow direction of the shielding gas 42, a second segment 32 extending in a direction that is partially transverse (e.g., diagonal) to the flow direction of the shielding gas 42, and a third segment 33 extending in a direction that is substantially parallel with flow direction of the shielding gas 42. The diagonal second segment 32 can be defined as having a first component 37 extending in a direction that is substantially parallel with the flow direction of the shielding gas and a second component 39 extending in a direction that is substantially transverse with flow direction of the shielding gas 42. FIG. 18 shows first component 37 and second component 39. The magnitude of first component 37 is preferably less than the magnitude of second component 39. The laser beam moves along first segment 31 and third segment 33 in a direction that is into the flow direction of shielding gas 42.

FIG. 10 illustrates a second exemplary embodiment of a weld pattern 300 wherein the laser beam always moves in a direction that is either substantially transverse to the flow direction of shielding gas 42 or in a direction that is substantially into the flow direction of shielding gas 42. The laser beam begins at a starting point 30 and stops at end point 40. The illustrated weld pattern 300 includes a first segment 31 extending in a direction that is substantially parallel with the flow direction of shielding gas 42 and a second segment 32 extending in a direction that is partially transverse with the flow direction of shielding gas 42. Referring again to FIG. 18, second segment 32 can be defined as having a first component 37 extending in a direction that is substantially parallel with the flow direction of shielding gas 42 and a second component 39 extending in a direction that is substantially transverse with shielding gas 42. The magnitude of first component 37 is preferably less than the magnitude of second component 39.

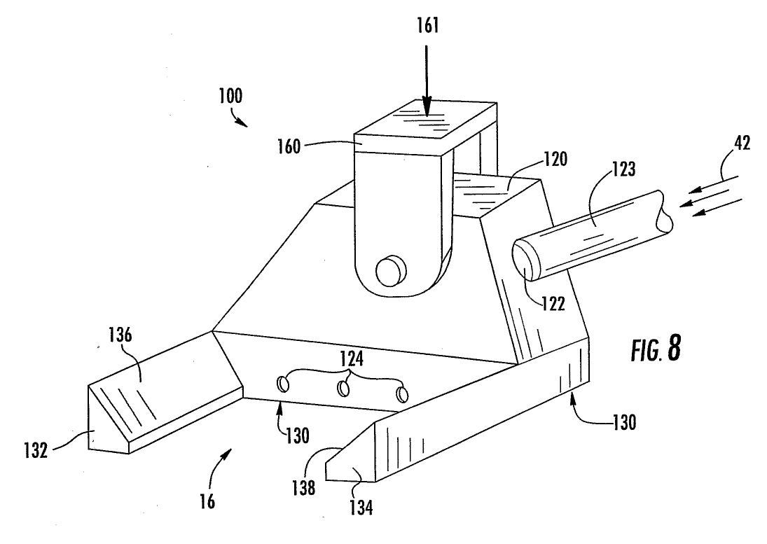

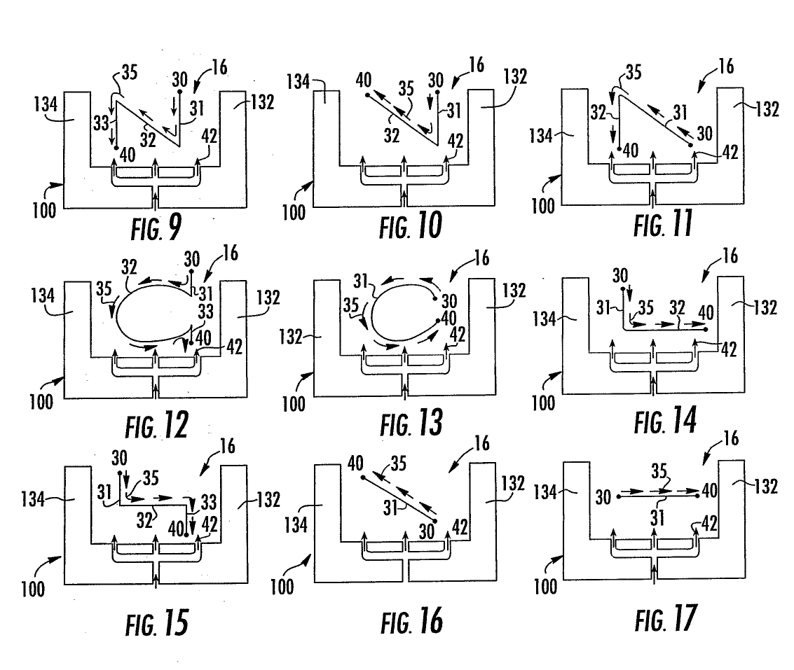

FIG. 11 illustrates a third exemplary embodiment of a weld pattern 300 wherein the laser beam always moves either substantially transverse to the flow direction of shielding gas 42 or in a direction that is substantially into the flow direction of shielding gas 42. The laser beam begins at a starting point 30 and stops at end point 40. The illustrated weld pattern includes a first segment 31 extending in a direction that is partially transverse with the flow direction of shielding gas 42 and a second segment 32 extending in a direction that is substantially parallel with the flow direction of shielding gas 42. Referring again to FIG. 18, first segment 31 can be defined as having a first component 37 extending in a direction that is substantially parallel with the flow direction of shielding gas 42 and a second component 39 extending in a direction substantially transverse with the flow direction of shielding gas 42. The magnitude of first component 37 is preferably less than the magnitude of second component 39.

FIG. 12 illustrates a fourth exemplary embodiment of a weld pattern 300 wherein the laser beam always moves in a direction that is either substantially transverse to the flow direction of shielding gas 42 or in a direction that is substantially into the flow direction of shielding gas 42. The laser beam begins at a starting point 30 and stops at end point 40. The illustrated weld pattern 300 includes a first segment 31 extending substantially parallel with the flow direction of shielding gas 42, a second segment 32 that is a curvilinear segment, a third segment 33 extending substantially parallel with the flow direction of shielding gas 42. With reference to FIG. 19, at any position where second segment 32 is moving away from the flow direction of shielding gas 42 (i.e., not into or substantially transverse to the flow direction of the shielding gas 42), the second segment does not include a curved edge where a tangential line 41 could be drawn having a first component 43 extending parallel with the flow direction of shielding gas 42 that is greater in magnitude than a second component 45 extending substantially transverse to the flow direction of shielding gas 42. The laser beam moves along first segment 31 and third segment 33 in a direction that is into the flow direction of shielding gas 42.

FIG. 13 illustrates a fifth exemplary embodiment of a weld pattern 300 wherein the laser beam always moves in a direction that is either substantially transverse to the flow direction of shielding gas 42 or in a direction that is substantially into the flow direction of shielding gas 42. The illustrated weld pattern includes a first segment 31 that is a curvilinear segment beginning at a start point 30 and extending to an end point 40. Referring again to FIG. 19, at any position where first segment 31 is moving away from the flow direction of shielding gas 42, the first segment does not include a curved edge where a tangential line 41 could be drawn having a first component 43 extending parallel with the flow direction of shielding gas 42 that is greater in magnitude than a second component 45 extending substantially transverse to the flow direction of shielding gas 42.

FIG. 14 illustrates a sixth exemplary embodiment of a weld pattern 300 wherein the laser beam always moves in a direction that is either substantially transverse to the flow direction of shielding gas 42 or in a direction that is substantially into the flow direction of shielding gas 42. The laser beam begins welding at start point 30 and stops welding at end point 40. The illustrated weld pattern 300 includes a first segment 31 extending in a direction that is substantially parallel with the flow direction of shielding gas 42 and a second segment 32 extending in a direction that is substantially transverse to the flow direction of shielding gas 42.

FIG. 15 illustrates a seventh exemplary embodiment of a weld pattern 300 wherein the laser beam always moves in a direction that is either substantially transverse to the flow direction of the shielding gas 42 or in a direction that is substantially into the flow direction of shielding gas 42. The illustrated weld pattern includes a first segment 31 extending in a direction that is substantially parallel with the flow direction of shielding gas 42, a second segment 32 extending in a direction that is substantially transverse to the flow direction of shielding gas 42, and a third segment 33 extending in a direction that is substantially parallel with the flow direction of shielding gas 42. The laser beam moves along first segment 31 in a direction that is into the flow direction of shielding gas 42.

FIG. 16 illustrates an eighth exemplary embodiment of a weld pattern 300 wherein the laser beam always moves in a direction that is either substantially transverse to the flow direction of shielding gas 42 or in a direction that is substantially into the flow direction of shielding gas 42. The illustrated weld pattern 300 includes a first segment 31 extending in a direction that is partially transverse to the flow direction of shielding gas 42 between a start point 30 and an end point 40. Referring again to FIG. 18, first segment 31 can be defined as having a first component 37 extending in a direction that is substantially parallel with the flow direction of shielding gas 42 and a second component 39 extending in a direction that is substantially transverse with the flow direction of shielding gas 42. The magnitude of the first component 37 preferably less than the magnitude of the second component 39.

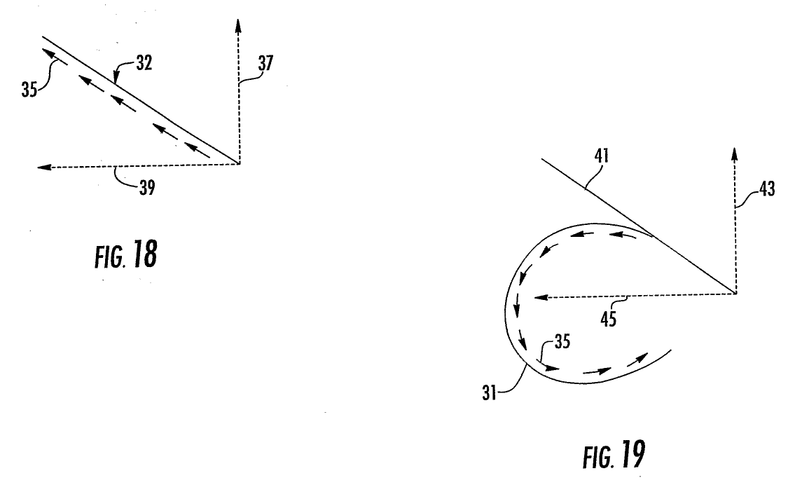

FIG. 17 illustrates a ninth exemplary embodiment of a weld pattern 300 wherein the laser beam always moves in a direction that is either substantially transverse to the flow direction of shielding gas 42 or in a direction that is substantially into the flow direction of shielding gas 42. The illustrated weld pattern 300 includes a first segment 31 extending in a direction that is substantially transverse to the flow direction of shielding gas 42 between a start point 30 and an end point 40.

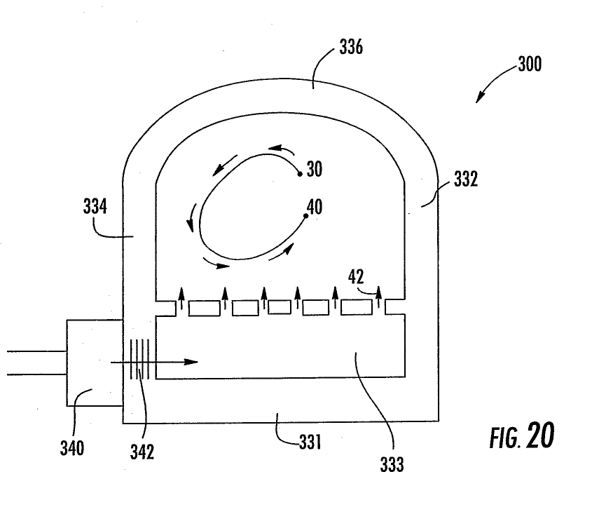

While the various exemplary embodiments shown herein have illustrated fixture systems (e.g., fixture system 100) as having a particular shape and design, it should be noted that according to other exemplary embodiments, other configurations may be used for such fixture systems. For example, FIG. 20 is a schematic top cross-sectional view of a fixture system 300 according to another exemplary embodiment. As shown in FIG. 20, the fixture system 300 includes a body portion 331 toward the rear of the fixture system 300, two legs 332 and 334, and a forward portion or bridge 336 extending between the two legs 332 and 324 (illustrated as having a rounded configuration in FIG. 20, although the particular configuration may differ according to other exemplary embodiments). Together the body portion 331, legs 332, 334, and bridge 336 define an area for providing a weld pattern that is circumscribed by portions of the fixture system 300 (e.g., as shown in FIG. 20, the weld pattern is formed within the opening defined by these components of the fixture system 300). By providing bridge 336 coupled to legs 332 and 334, it is intended that a more uniform clamping force may be applied to the workpiece to hold the layers of the workpiece in intimate contact with each other.

As also illustrated in FIG. 20, while the fixture system 100 as illustrated in FIGS. 9-17 receive the shielding gas from an opening provided in a rear surface of the fixture, according to an exemplary embodiment such gas may be received through an inlet formed in the side of the fixture 300. As illustrated in FIG. 20, a tube or hose 340 may be coupled to an opening in the side of the fixture 300 and secured in place with a threaded connection 342 (e.g., a bolt, etc.). A chamber or channel 333 is provided in the fixture 300 to act as a manifold for routing shielding gas (illustrated by arrows 42) to the area where welding is to occur. As shown in FIG. 20, six openings are formed in the fixture for delivering the shielding gas to the weld spot, although according to other exemplary embodiments a different number of openings may be provided.

It will be appreciated by tho se reviewing this disclosure that various exemplary embodiments have been described herein, and that features described with respect to one embodiment may also be utilized in conjunction with other exemplary embodiments. According to one such embodiment, a method of increasing penetration and/or reducing porosity of a weld formed by a remote beam laser welding system includes the step of supplying a shielding gas to a weld spot before and/or during when a laser beam is applied to the weld spot. According to an exemplary embodiment, the shielding gas is an inert gas, and/or a mixture of or including an inert gas, such as helium or argon. In another embodiment, the shielding gas may include nitrogen and/or air. The shielding gas interacts with, and suppresses, a laser-induced plasma.

According to another exemplary embodiment, a method of welding a workpiece with a remote beam laser welding system having a power level greater than approximately 2 kW includes the steps of applying clamping force to the workpiece to achieve and maintain a desired gap width between members of the workpiece, directing a laser beam to a weld spot on the workpiece, and supplying shielding gas to the weld spot. The method optionally includes the step of employing a force measuring system to measure the clamping force applied to the workpiece and determine whether the desired gap size has been achieved. According to an exemplary embodiment, the force measuring system is a strain gauge/load cell the output of which is calibrated to correlate to the desired gap size.

According to another exemplary embodiment, a method of welding a workpiece with a remote beam laser welding system having a power level greater than approximately 2 kW includes the step of providing a weld pattern wherein the laser beam does not move in a direction that is substantially away from the flow direction of the shielding gas. Such a weld pattern is configured to optimize the effectiveness of the shielding gas thereby increasing penetration and/or reducing porosity.

According to another exemplary embodiment, the weld pattern produced by the remote beam laser is substantially Z-shaped in that it has three segments. A first segment and a third segment extend in a direction aligned substantially parallel with the direction of the flow direction of the shielding gas. The second segment extends substantially diagonally between the first segment and the second segment. The diagonal of the second segment includes a first component extending substantially parallel with the shielding gas and a second component extending substantially perpendicular to the shielding gas. In one exemplary embodiment, the magnitude of the first component is not greater than the magnitude of the second component. The laser beam moves along the first and third segments in a direction that is into (e.g., frontal to, towards, etc.) the flow direction of the shielding gas.

According to another exemplary embodiment, a fixture system for use with a remote beam laser welding system supplies a shielding gas to a weld spot during a welding process. The fixture system includes a body portion having a first or inlet aperture for receiving a shielding gas from a shielding gas source, and a second or outlet aperture for providing the shielding gas to the weld spot. A conduit fluidly couples the first aperture and the second aperture. The body portion optionally includes a chamber disposed between the first aperture and the second aperture and configured to receive and retain the shielding gas until needed during the welding process.

According to another exemplary embodiment, a fixture system for use with a remote beam laser welding system is further configured to function as a clamping device and includes a clamping mechanism having a generally flat surface configured to transfer a clamping force from a clamping system proximate to the weld spot to draw together at least two materials of a workpiece that are being welded.

According to another exemplary embodiment, a method of suppressing plasma generated during a remote beam laser welding process includes the steps of positioning a fixture system proximate or near (sufficiently close to effectively deliver the shielding gas and effectively suppress the laser-induced plasma) a weld spot, and delivering a shielding gas to the fixture system. The fixture system includes a shielding gas inlet and shielding gas outlet. The method further includes the step of supplying the shielding gas from the fixture system to weld spot so that the shielding gas suppresses the laser-induced plasma generated during penetration. The shielding gas may be supplied before the laser beam penetrates the weld spot and/or the shielding gas may be supplied as the laser beam penetrates the weld spot.

According to another exemplary embodiment, a method of welding together at least two materials using a remote beam laser system includes the steps of applying a clamping force to a weld spot until a gap size of less than 0.3 mm is achieved and maintained, applying a laser beam emanating from a work head to the weld spot. The method further includes of the step of providing a shielding gas to the weld spot before and/or during when the laser beam is applied to the weld spot. The method further includes the step of providing a single fixture system to apply the clamping force and supply the shielding gas. The method optionally includes the step of employing a force measuring system to measure the clamping force being applied to the weld spot to determine whether the gap size of less than 0.3 mm has been achieved. According to an exemplary embodiment, the force measuring system is a strain gauge/load cell.

It will be appreciated by those reviewing this disclosure that the methods and systems herein provide various advantageous features for remote beam laser welding processes. For example, such methods and systems provide an increased degree and/or rate of penetration of a laser beam and reduced porosity for welds formed during a remote beam laser welding process that employs a laser having a power level greater than approximately 2 kW. Such methods and systems also are intended to maintain the stability of keyholes during the remote beam laser welding process by suppressing laser-induced plasma that reflects and/or absorbs energy of a laser beam of the remote beam laser welding system. The fixture systems act to supply a shielding gas to a weld spot during a remote beam laser welding process and also function as clamping devices.

It is to be understood that the invention is not limited to the details or methodology set forth in the this detailed description or as illustrated in the drawings. The invention is capable of other embodiments or being practiced or carried out in various ways. It is also to be understood that the phraseology and terminology employed herein is for the purpose of description with respect to the embodiments shown and should not be regarded as limiting.

It is important to note that the construction and arrangement of the elements of the fixture system as shown in the various exemplary embodiments are illustrative only. In addition, it is important to note that the weld patterns shown in the various exemplary embodiments are not exhaustive. Although several embodiments of the present invention have been described in detail in this disclosure, those skilled in the art who review this disclosure will readily appreciate that modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the claims. For example, the scale of the weld patterns shown throughout the FIGURES is for illustrative purposes only. Accordingly, all such modifications are intended to be included within the scope of the present invention as disclosed. The order or sequence of any process or method steps may be varied or re-sequenced according to other exemplary embodiments. Other substitutions, modifications, changes and/or omissions may be made in the design, operating conditions and arrangement of the various exemplary embodiments without departing from the spirit of the present invention as expressed in this disclosure.

What is claimed is:

1. A remote beam laser welding system comprising:
a mechanism comprising at least one mirror for directing a laser beam at a power level greater than approximately 2 kW to a weld spot of a workpiece; and
a device configured to direct a shielding gas to the weld spot.

2. The remote beam laser welding system of claim 1, wherein the device is also configured to provide a clamping force proximate the weld spot.

3. The remote beam laser welding system of claim 1, wherein the device comprises a body and a plurality of legs extending from the body.

4. The remote beam laser welding system of claim 3, wherein each of the legs include an inclined surface.

5. The remote beam laser welding system of claim 4, wherein the device comprises a bridge that extends between the two legs, the body portion, legs, and bridge defining an area in which a workpiece may be welded.

6. The remote beam laser welding system of claim 1, wherein the device comprises at least one outlet provided proximate the weld spot for directing the shielding gas.

7. The remote beam laser welding system of claim 1, wherein the device comprises a plurality of outlets provided proximate the weld spot for directing the shielding gas.

8. The remote beam laser welding system of claim 7, wherein the device comprises a chamber for routing the shielding gas to the plurality of outlets.

9. The remote beam laser welding system of claim 1, wherein the shielding gas comprises at least one gas selected from the group consisting of helium, nitrogen, and air.

10. The remote beam laser welding system of claim 1, wherein the laser beam is provided at a power level greater than approximately 4 kW.

11. The remote beam laser welding system of claim 1, wherein the laser beam is provided using a CO₂ laser.

12. The remote beam laser welding system of claim 1, further comprising at least one additional device configured to direct a shielding gas to a weld spot.

13. A method of welding a workpiece comprising:
providing a flow of shielding gas to a weld spot on a workpiece, the gas having a flow direction;
directing a laser beam at the weld spot using a remote beam laser welding system; and
forming a weld by moving the laser beam in a direction different than the flow direction to reduce interaction between the laser beam and a plasma plume formed proximate the weld spot.

14. The remote beam laser welding system of claim 13, wherein the step of moving the laser beam comprises moving the laser beam in a direction that is substantially perpendicular to the flow direction.

15. The remote beam laser welding system of claim 13, wherein the step of moving the laser beam comprises moving the laser beam in a generally circular pattern.

16. The remote beam laser welding system of claim 13, wherein the step of moving the laser beam comprises moving the laser beam in a generally Z-shaped pattern.

17. The remote beam laser welding system of claim 13, wherein the step of moving the laser beam comprises moving the laser beam in a direction that is substantially opposite the flow direction.

18. The remote beam laser welding system of claim 13, wherein the step of moving the laser beam comprises moving the laser beam in a direction that is not primarily in the same direction as the flow direction.

19. The remote beam laser welding system of claim 13, wherein the laser beam is provided at a power level greater than approximately 2 kW.

20. The remote beam laser welding system of claim 13, wherein the laser beam is provided using a CO₂ laser.

21. The remote beam laser welding system of claim 13, wherein the shielding gas is selected from the group consisting of helium, nitrogen, air, and mixtures thereof.
